(19) United States
(12) Patent Application Publication
(10) Pub. No.: US 2007/0048102 A1
(43) Pub. Date: Mar. 1, 2007

(54) Arc Cutter For Stone or Ceramic Material

(76) Inventor: Raphael Picon Lopez Tristancho, Rockledge, FL (US)

Correspondence Address: JOEL I ROSENBLATT, 445 11TH AVENUE, INDIALANTIC, FL, 32903, US

(21) Appl. No.: 11/307,563

(22) Filed: Feb. 13, 2006

Related U.S. Application Data
(60) Provisional application No. 60/596,062, filed on Aug. 29, 2005.

(51) Int. Cl. B23D 5/00

(52) U.S. Cl. 409/293; 409/304; 409/348

(57) ABSTRACT

A cutting too for making arcuate cuts in a stone or ceramic material work piece uses a rotary cutting tool mounted on a pivoting radial arm with the plane of the cutting tool perpendicular to the radial arm. Rotation of the radial arm moves the cutting tool in an arcuate path producing an arcuate cut in the work piece. The cutting head may be indexed to the work piece by means of a screw or stepping device.

### CROSS REFERENCE TO RELATED APPLICATIONS

The benefit of the earlier filing date under 35 U.S.C. 120, of Provisional Application 60/596,062, Filing Date: Aug. 29, 2005, is claimed for this application.

### FIELD OF THE INVENTION

This invention is in the field of stone, tile and other ceramic, cutting devices.

### BACKGROUND OF THE INVENTION

Title and stone cutting is a well know practice, as shown in archeological ruins as known in the modern world. Tile setting, whether in antiquity or in our modern era, and as seen in most tile installations, is in rectilinear patterns with tiles preferably comprised of straight edges, as the easiest and most accurate way of cutting tile in pieces to fit a pattern. However, instances arise where the pattern requires tile be cut in a precise curved or arcuate pattern, meaning in a pattern with one or more arcs of difference respective radius and center locations.

In these instances, the tile cutter must resort to hand cutting of the precise arc, or small pieces, small enough to define a curve when placed in a pattern and to mesh into an adjoining pattern. As is well known in the art, any mis-cuts, prevents a smooth placement of the cut tile on the first try and could leave uneven open spaces, spoiling the pattern's overall appearance.

### SUMMARY

The disclosed inventive principles, as shown for a disclosed preferred embodiment, eliminates the problems of accurately cutting arcs in stone or tile, or other hard or ceramic material, by hand and enables an efficient machine cut of a precise arc, of varying radius and arc circumferential lengths, in a curvilinear pattern, as may be required in fitting one more pieces of tile cut in radian related arcs or radian circumferential lengths, over into a meshing or adjoining arcuate pattern.

An object of this invention is a tile or ceramic or other hard surface cutting tool that can be moved in a repeatable arcuate path over a work piece for making arcuate cuts in the work piece.

An object of this invention is a tile or ceramic or other hard surface cutting tool, that can be arranged to make precise arcuate cuts in paths varying in radius or radians, or circumferential arcuate lengths.

Another object of the invention is a tile or ceramic or other hard surface cutting tool, that can be indexed into the work piece to make progressively deeper cuts as the cutting tool is moved in a repeatable arcuate path, enlarging the arcuate cut until the work piece is separated into the arcuate cut finished piece and the remaining stock.

The disclosed invention, as shown by the disclosed inventive principles, is able to control the cutting of a precise arc, or radial distance according to a preset radius and arc length and angle traversed or the radian arc traversed.

According to a preferred embodiment, a rotary cutting blade is mounted on a radial arm with the plane of rotating blade substantially perpendicular to the radial arm longitudinal axis.

The radial arm is mounted for pivoting movement about an axis through a shaft bearing located proximate a work support surface. Locating the bearing for the radial arm shaft proximate the work surface, allows a more precise alignment of the rotating cutting blade at its point of cutting contact with the work surface, with the center of the axis of rotation of the radial arm and a more precise cut arc, all of which is the object the invention.

As shown in a preferred embodiment, the radially mounted cutting head supporting a cutting blade, is rotated about the axis of rotation through the radial arm support shaft, moving about the axis and cutting an arc and an arcuate path, in the tile or stone, or other ceramic work surface, at the point of contact of the cutting blade with the work. An indexing head is provided for movement of the cutting blade on the cutting head, substantially in an indexing direction parallel to the axis of rotation of the radial arm and progressively into the work piece, to allow a progressive cutting of the work as the indexing head and the blade is arcuately rotated through an arc of a desired radial distance.

An alignment support device comprised by the cutting head is disclosed in two separate pieces with a first alignment plate located at one end of the radial arm opposite the axis of rotation. The purpose of the alignment plate, as shown in a preferred embodiment, is to permit the alignment of the cutting head support plate for the cutting tool and the cutting tool, substantially with the plane of a planar cutting tool perpendicular to the radial arm longitudinal axis and with the plane of the planar cutting tool aligned parallel to the indexing direction into the work piece.

In this way a substantial advantage is obtained as a minimum point of contact of the too cutting surface with the work surface can be made, consistent with a smoothly cut arc, as would be known to those skilled in the art of cutting hard material like stone, or ceramics.

As shown for a preferred embodiment, the indexing head may be arranged with a screw for continuous or progressive advancement of the head components down toward the work surface, as with each successive pass of the radial arm and the cutting head in the preferred intended arc or the indexing head may be arranged for a downward progressive movement of the cutting tool, in steps with an incremental control adjusted for the work hardness, the type of cutting tool or blade and the depth of cut desired for each radial pass of the cutting head.

The advantage of the radial arm arcuate cutting tool, as shown and described in a preferred embodiment, are repeatable precise arcuate cuts in a hard stone or ceramic material by the combined rotation of the rotating cutting surface through the locus of a preset arc or radial distance, while progressively indexing the cutting too or blade downward and deeper into the arcuate cut, to finish the cutting process.

What is shown and described in a preferred embodiment is a cutting tool or blade for making arcuate cuts in tile or other ceramic or hard materials comprising, a radial arm means; first means for supporting the radial arm means for movement about an axis of rotation; the radial arm means comprising second means for supporting a planar cutting tool; the second means comprising third means for indexing movement of the second means in an indexing direction toward a work piece; the second means comprising means for supporting the cutting tool or blade with the plane of the cutting tool orthogonal to the radial arm, for cutting an arcuate path in response to the movement of the radial arm means about the axis of rotation, and in response to the indexing movement of the third means.

In the disclosure of a preferred embodiment, is shown the second means comprises a support plate means and an alignment plate means; the support plate means comprises means for mounting the cutting tool; and wherein the third means is mounted on the alignment plate means for the indexing movement of the support plate means, relative to the alignment plate means. The means for indexing comprises means for progressively indexing the first means, and the means for indexing, comprises means for continuously moving the first means into a work piece.

Additionally shown in a preferred embodiment is the alignment plate means comprises means for rotational movement of the support plate means and the means for indexing comprises means for rotating the cutting tool in the plane of the cutting tool, about the means for rotational movement, through an arcuate path in a indexing direction to or from the work piece and in a plane orthogonal to the axis of the radial arm means and parallel to the axis of rotation.

The support plate means is shown as comprising means for movement of the support plate means in the indexing arcuate path and comprising means for clamping the support plate means in a set position within the arcuate path. As disclosed, the third means comprises a support plate means and an alignment plate means and means for mounting the support plate means for movement relative to the alignment plate means in the indexing direction; and wherein the third means comprising means for driving the cutting tool in the arcuate indexing direction in the arcuate path of a slot in the support plate means.

As disclosed in a preferred embodiment, the arcuate indexing direction is in a plane, substantially perpendicular to the radial arm and the alignment means comprises means for mounting the third means on the alignment means. The disclosed means for driving the cutting tool in the arcuate indexing direction, comprises a shaft means; means for moving the shaft means in the axial direction of the shaft means, and means on the support plate means for following the movement of the shaft means displacing the support plate in the arcuate indexing direction and through the arcuate path.

The operation of the disclosed system is for making repeatable arcuate cuts in a tile or other ceramic surface, comprising, a planar rotating cutting tool; the rotating cutting tool comprising a cutting edge in the plane of the rotating cutting tool; a radial arm with a radial arm axis extending along the radial arm.

The cutting tool is mounted on the radial arm; and the radial arm is mounted in the bearing for axial rotation about the axis of the bearing; the rotating cutting tool mounted on the radial arm for rotation in an arcuate path about the bearing axis. The rotating cutting tool is mounted on the radial arm with the radial arm axis passing through the plane of the rotating cutting tool and he radial arm axis is orthogonal to the plane of the rotating cutting tool.

As shown in a preferred embodiment, a cutting head is mounted on the radial arm; the cutting tool mounted on the cutting head; the cutting head comprising a movable support plate and an alignment plate.

The alignment plate is mounted on the radial arm, supporting the support plate; an indexing tool is arranged with a first part connected to the alignment plate and a second part connected to the support plate; the rotating cutting tool is mounted on the support plate. The indexing tool mounted on the alignment plate for displacement relative to the alignment plate and for moving the support plate in response to the displacement.

The indexing tool has a first part comprising a support for a shaft mounted on the alignment plate for movement of the shaft along the axis of the shaft and second part comprising a support for the shaft on the support plate for movement of the support plate in responses to the movement of the shaft. The support plate may be mounted on a rotational axis on the alignment plate for rotational movement and the support plate comprises an arcuate slot radially opposed to the rotational axis; and clamps disposed in the arcuate slot and cooperating with the arcuate slot for clamping the support plate to the alignment plate. In this arrangement, the displacement of the indexing head is parallel to the axis of rotation of the radial arm and wherein the radial arm axis is substantially perpendicular to the plane of the rotating cutting tool.

Additionally shown for a preferred embodiment is a method for making repeatable and progressively deeper arcuate cuts in a tile or ceramic material comprising the steps of, mounting a rotating planar cutting tool on a radial arm mounted on an axis of rotation, with the plane of the cutting tool perpendicular to the direction of the radial arm and parallel to the axis of rotation of the radial arm; indexing the cutting tool in the plane of the cutting tool and in the direction of a work piece and moving the radial arm to cause the rotating cutting tool to arcuately engage a work piece to make an arcuate cut. The method may comprise the steps of mounting the rotating planar cutting tool comprises the step of mounting an alignment plate to the radial arm; mounting a support plate on for indexing movement on the alignment plate and mounting the rotating cutting tool on the support plate and wherein the step of indexing the cutting tool comprises the step of continuously indexing the cutting tool.

### BRIEF DESCRIPTION OF THE DRAWINGS

FIG. 1 shows in a schematic perspective view, a preferred embodiment of the disclosed invention.

FIG. 2 shows in a schematic view, the cutting head support plate

FIG. 2a shows in a schematic partial view, the cutting head support plate indexing screw and its pin for insertion into an aperture in the alignment plate.

FIG. 3 shows in schematic form, and in a top view, the support plate juxtaposed with the alignment plate and arcuate movement of the cutting blade in an arcuate path about the axis of the radial arm supporting the cutting blade.

FIG. 4 shows in schematic form, the back surface of the alignment plate, with the direction shown for the insertion of the pin shown in FIG. 2a.

### DESCRIPTION OF THE INVENTION

The invention is shown generally in a schematic perspective view 11, as comprising a work support surface 13 on which a tile or other stone or ceramic work piece may be supported proximate a cutting too 15. The cutting tool 15 is shown in a preferred embodiment as a planar rotating cutting blade 15 with a cutting edge at the periphery of the cutting blade, as would be well known to those skilled in the art. The cutting tool is mounted for rotating movement by motor 17. As would be apparent to those skilled in the art, the rotating cutting tool 15 is circular with the cutting edge of the rotating cutting blade tool located in a plane, at the periphery of the rotating cutting blade 15.

For the purpose of explanation with reference to a disclosed preferred embodiment, the planar cutting tool 15 may be referred to as a cutting tool or blade or rotating cutting blade or rotating cutting tool, all referring to any suitable cutting tool as would be known to those skilled in the art. The cutting head may be referred to as comprising the alignment plate 33, and support plate 31 with the indexing means for progressively displacing the cutting tool 15 toward the work piece 12 on worktable 13.

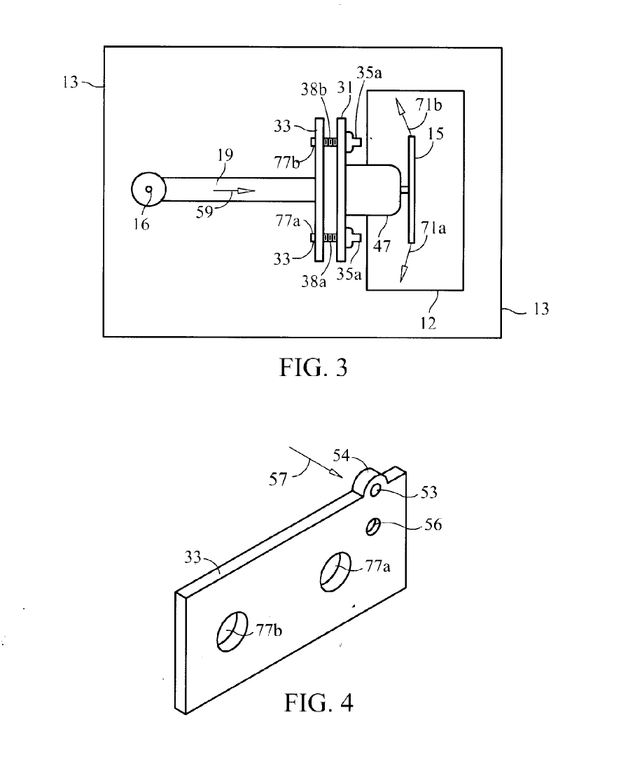

A radial arm 19 with a radial arm axis is shown supported on a shaft or column 21. The shaft 21 is mounted for substantially free rotation within bearing 23 mounted within the work support surface 13. The position of the radial am 19 relative to an axis of rotation 16, as shown in FIG. 3, of the shaft 21 in bearing 23, and radius of the arc made by the cutting blade 15, mounted at the end of the radial arm 19, may be adjusted, as shown in a preferred embodiment by a bracket 25 which may be used to hold the radial arm 19 in a friction fit by forcing the bracket 25 against the radial arm 19 by turn screws 27a and 27b, as would be well known to those skilled in the art. The invention is not limited to the brackets disclosed for a preferred embodiment for adjusting the arc of movement of the cutting blade 15 over the work support surface 13, and as well known to those skilled in the art, any suitable bracket may be made for adjusting the length of the radial arm 19, or for positioning the cutting blade 15 on the radial arm 19, for adjusting the radius of the arc and the length of the arcuate path, made by the path of the cutting tool blade 15, over a work surface 13. As shown for a preferred embodiment, the cutting edge of the cutting tool 15, shown in a preferred embodiment as a rotating cutting blade is in a plane formed by the cutting blade 15 and is orthogonal to the radial arm 19 and the radial arm direction or axis, 59, as shown in FIG. 3.

As shown for a preferred embodiment, in FIG. 3, the axis of rotation 16, of shaft 21, when fixed within bearing 23, would be outside the work piece 12, relative to its position under the cutting head comprising the support plate 31 supporting the cutting tool 15, as would be understood by those skilled in the art. However, as would be apparent to those skilled in the art, the axis 16 could be over a work piece 12, if suspended on a support anchored outside the work piece 12.

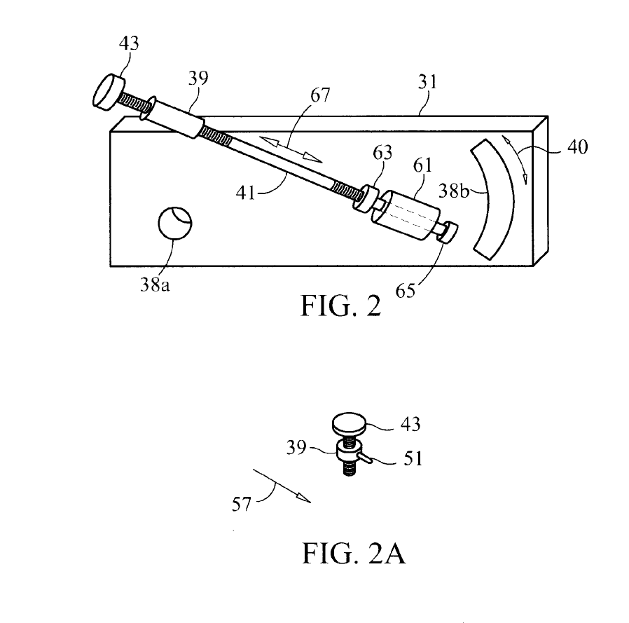

The motor 17 driving the cutting blade 15, is shown mounted on a cutting head support plate 31. An alignment plate 33, is shown behind the cutting head support plate 31. In a preferred embodiment, the cutting head support plate 31 is attached to the alignment plate by threaded screws 35a and 35b, passing though alignment plate 31, apertures 38a and 38b, as shown in FIGS. 2 and 3, and held in a threaded apertures 77a and 77b, as shown in FIGS. 3 and 4. The screws 35a and 35b, may be turned to force the cutting head support plate 31 against the alignment plate 33, to hold or clamp the cutting tool blade 15 in a precise indexed position relative to its distance to a work surface. As would be apparent to those skilled in the art, other suitable clamp means may be used to clamp or hold the support plate 31 in a fixed position relative to the alignment plate 33.

In a preferred embodiment, the cutting head support plate 31 may be mounted for rotating movement about screw 35a through aperture 38a and the axis of aperture 38a, as shown in FIG. 2 and serving as a pivot for movement of the cutting head support plate 31 through the arcuate path shown by arcuate slot 38b, and in the arcuate indexing direction or path of arrow 40. As shown for a preferred embodiment, screw 35b is inserted through the arcuate slot 38b, to engage a mating threaded aperture 77b in alignment plate 33, as shown in FIG. 4. The screw 35b passing through arcuate slot 38b, may be used to clamp the support plate 31 in a position relative to the alignment plate 33 at a set position in said arcuate slot 38b. As shown for a preferred embodiment, the arcuate slot 38b is opposed to aperture 38a and is in an arcuate indexing path of rotation relative to the axis of passing through aperture 77a in alignment plate 33 and aperture 38a in support plate 31. As shown for a preferred embodiment, the arcuate slot 38b, is in the radial direction from aperture 77a. By indexing path or direction is meant the direction of movement of the cutting head support plate 31 and the cutting tool 15, in the direction of the work piece 12.

The support plate 31 and cutting tool 15, may be indexed in an indexing direction or path to the work piece 12, on the work table 13, by means of an indexing means shown in a preferred embodiment as comprising a threaded boss 39 positioned relative to the alignment plate 33 by pin 51 when inserted in aperture 53 or 56 in alignment plate 33, and which is internally threaded. In a preferred embodiment, an indexing or positioning screw 41 engages the threaded boss 39 and has at its end a screw handle 43. The opposite end of indexing screw 41 is mounted on cutting head support plate 31 to move the cutting head support plate 31 and the cutting tool 15, about the axis of the screw 35a in and through the aperture 38a, and through the arc described by the arcuate path of slot aperture 38b, as the screw 41 is turned clockwise or counter clockwise.

As shown and described for a preferred embodiment, the cutting head support plate 31 and the planar cutting tool or blade 15 may be progressively indexed in the indexing path in the plane of the cutting tool 15 and in the rotational or arcuate direction of the radial arm support 21 about the axis 16, to move the cutting head blade, into deeper engagement with a work piece 12 and into the plane of the work piece, as shown in the schematic overhead representation of FIG. 3. By indexing movement is meant a continuous or step movement, of the cutting tool 15, in the direction to the work piece 12, as would be known to those skilled in the art. In the operation of the preferred embodiment, the indexing movement may be made between repeated arcuate movements of the cutting tool blade 15, in the arcuate path 71a, 71b, over the work piece 12.

In a preferred embodiment, as shown in a schematic view in FIG. 2, cutting head support plate 31 is shown with the rotary cutting blade 15 and the blade motor 17, removed for the purpose of explanation. As shown in the schematic representation of FIG. 2a, the threaded boss 39 may be fixed in position relative to the alignment plate 33 by means of a positioning pin 51 positioned in the threaded boss 39, and placed within support aperture 53 or 56, within alignment plate 33, in the direction of arrow 57, as shown in FIGS. 2a and 4. The pin may be fastened in place by any suitable means known to those skilled in the art. Positioning pin 51 is used in cooperation with aperture 53 or 56 on alignment plate 33, to position the boss 39 relative to the alignment plate 33 and to position the cutting head support plate 31 and the cutting tool 15, relative to the alignment plate 33.

For a preferred embodiment, the support aperture 53, may be mounted in an appendage or extension, 54 to plate 33 or within plate 33 as shown by support aperture 56. The end of indexing screw 41 opposite the boss 39, is attached to the cutting head support plate 31 by means of a boss 61 attached to the cutting head support plate 31, through which the threaded screw 41 passes. Movement of the cutting head support plate about an axis through the aperture 38a and through the arcuate path of slot 38b, in the arcuate path 40, is by the interaction of bosses 63 and 65, on boss 61 on indexing screw 41. As would be apparent to one skilled in the art, as indexing screw 41 rotates, it moves in its axial direction 67 through threaded boss 39 moving boss 65 into contact with cutting heard support plate 31, boss 61 and rotating the cutting head support plate 31 counter clockwise relative to the axis through aperture 38a and in the arcuate path direction 40 through the arcuate path slot 38b. Similarly, as indexing screw is rotated in the opposite direction, it forces boss 63 into contact with cutting head support plate boss 61, forcing cutting head support plate 31 to rotate clockwise about the axis through aperture 38a in the arcuate direction 40 and through the arcuate slot space 38b, in the arcuate path 40. As would be understood by those skilled in the art, the relative placement of boss 61 on plate 31 and placement of indexing screw 41 and threaded boss 39, is shown for a preferred embodiment, schematically and for the purpose of explanation and the relative positions of the cooperative elements, as shown and described, for indexing the cutting head support plate 31 and the cutting too 15, may be varied without departing from the disclosed inventive principles.

In a preferred embodiment, the angle of the indexing screw 41 relative to the arcuate slot 40, and aperture 38a, is shown in the position of FIG. 2, for the purpose of explanation. As would be apparent to those skilled in the art, the angle of indexing screw 41 with respect to the axis of pin 51 through aperture 53 or 56, could be varied in an angular position, to rotate the indexing screw 41 closer to the aperture 38a, directing the force of the boss 61, more directly on boss 63 and 65, closer or more tangential to a desired point in the arcuate direction or path of rotation 40 of slot 38b about the axis described by aperture 38a.

Once the correct indexing position of the cutting tool 15 is reached for the progressive pass of the cutting head into the work piece 12, in the arcuate path 71a, 71b, as shown in FIG. 3, the cutting head support plate 31 may be fixed into position by use of a suitable clamp, shown in a preferred embodiment as set screws 35a and 35b, passing through aperture 38a in the cutting head support plate 31 and into the threaded aperture 77a in the alignment plate 33 and through slot 38b in the cutting head support plate 31 and threaded aperture 77b in the alignment plate 33, respectively, as shown in FIG. 4.

As would be apparent to those skilled in the art, other suitable arrangements may be used for indexing the cutting head support plate 31 and the rotary cutting head 15 toward the work piece on the work support surface 13, or for holding the support plate 31 and cutting head 15 in precise position relative to the work surface 13, without departing from the disclosed inventive principles.

Operation of the arcuate cutting tool is shown in the schematic representation of FIG. 3. As disclosed for a preferred embodiment, the cutting head comprising the support plate 31 and alignment plate 33, and cutting tool 15 mounted on motor 17, rotates about an axis 16 through in shaft 21, in the arcuate direction 71a, 77b, bringing the cutting tool 15, into cutting contact with the work piece 12 to make an arcuate cut in the arcuate direction or path shown by 71a, 71b.

Indexing of the cutting tool or blade 15 in the indexing path direction of the work piece 12 to make successive cuts as is known for ceramic or stone materials, may be by the indexing screw 41 or by any other suitable step or continuous indexing arrangement as would be known to those skilled in the art.

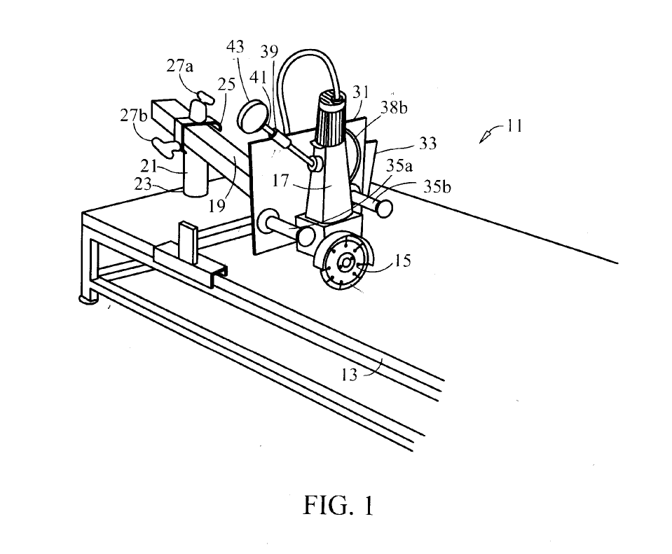

The side of the alignment plate 33 opposite to the side shown in FIG. 1, is shown in the schematic of FIG. 4. The alignment plate is shown detached from radial arm 19, for purpose of explanation. The threaded apertures 77a and 77b for set screws 35a and 35b are shown in alignment plate with aperture 77a, opposed to alignment aperture 53 for receiving alignment pin 51, as shown in FIG. 2a.

As may be seen from FIG. 1, for a preferred embodiment, when set screws 35a and 35b are screwed into the respective threaded apertures 77a and 77b, the cutting head support plate 31 is forced against alignment plate 33 and clamped in the desired preset position for positioning the cutting tool 15 in an indexed position relative to the work piece 12, as would be apparent to those skilled in the art.

These and other features of the invention as disclosed invention may be varied in achieving the functions of a radial arm cutting tool for ceramic or other hard surfaces, with the plane of the cutting tool or cutting head perpendicular to the radial arm and mounted for arcuate movement relative to the axis of rotation of the radial arm.

What is claimed is:

1. A cutting tool for making arcuate cuts in tile or other ceramic or hard materials comprising,
a radial arm means;
first means for supporting said radial arm means for movement about an axis of rotation;
said radial arm means comprising second means for supporting a planar cutting tool;
said second means comprising third means for indexing movement of said second means in an indexing direction toward a work piece;
said second means comprising means for supporting said cutting tool with the plane of said cutting tool orthogonal to said radial arm, for cutting an arcuate path in response to said movement of said radial arm means about said axis of rotation, and in response to an indexing movement of said cutting tool by said third means.

2. The cutting tool of claim 1, wherein,
said second means comprises a support plate means and an alignment plate means; said support plate means comprises means for mounting said cutting tool; and wherein said third means is mounted on said alignment plate means for said indexing movement of said support plate means, relative to said alignment plate means.

3. The cutting tool of claim 2, wherein said third means comprises means for progressively indexing said second means in a direction parallel to the plane of said planar cutting tool.

4. The cutting tool of claim 3, wherein, said third means comprises means for continuously moving said first means into a work piece.

5. The cutting tool of claim 2, wherein said alignment plate means comprises means for rotational movement of said support plate means and said third means comprises means for indexing movement of said cutting tool, about said alignment plate means through an arcuate path.

6. The cutting tool of claim 5, wherein said second means comprises means for movement of said support plate means in said arcuate path and comprising means for clamping said support plate means in a set position within said arcuate path.

7. The cutting tool of claim 1, wherein said second means comprises a support plate means and an alignment plate means and means for mounting said support plate means for movement relative to said alignment plate means in said indexing direction;
said support plate means comprises an arcuate slot path means; and
said third means comprising means for driving said support plate means in said indexing direction and in the arcuate path of said arcuate path slot means.

8. The cutting tool of claim 7, wherein said arcuate direction is in a plane, substantially perpendicular to said radial arm means.

9. The cutting tool of claim 7, wherein said alignment means comprises means for mounting said third means on said alignment means.

10. The cutting tool of claim 9, wherein said means for driving said cutting tool in said arcuate indexing direction, comprises a shaft means; means for moving said shaft means in the axial direction of said shaft means, and means on said support plate means for following said movement of said shaft means and for displacing said support plate in said arcuate indexing direction and through said arcuate path of said arcuate path slot means.

11. A system for making repeatable arcuate cuts in a tile or other ceramic surface, comprising,
a planar cutting tool;
said cutting tool comprising a cutting edge in the plane of said cutting tool;
a radial arm with a radial arm axis extending along said radial arm;
a bearing with an axis of rotation;
said radial arm mounted in said bearing for axial rotation about said axis of rotation;
said planar cutting tool mounted on said radial arm for rotation in an arcuate path about said bearing axis;
said cutting tool mounted on said radial arm with said radial arm axis passing through said plane of said planar cutting tool.

12. The system of claim 11, wherein said radial axis is orthogonal to said plane of said cutting tool.

13. The system of claim 11, comprising,
a cutting head mounted on said radial arm; said cutting tool mounted on said indexing head;
said cutting g head comprising a movable support plate and an alignment plate;
said alignment plate mounted on said radial arm and supporting said support plate;
an indexing tool with a first part connected to said alignment plate and a second part connected to said support plate;
said cutting tool mounted on said support plate;
said indexing tool mounted on said alignment plate for displacement relative to said alignment plate and for indexing movement of said indexing head support plate and said cutting tool, in response to said displacement of said indexing tool.

14. The system of claims 13, wherein said indexing tool first part comprises a support for a shaft mounted on said alignment plate for movement of said shaft along the axis of said shaft and said second part comprises a support for said shaft on said support plate for movement of said support plate in responses to said movement of said shaft.

15. The system of claim 11, wherein said support plate is mounted on a rotational axis in said alignment plate for rotational movement and said support plate comprises an arcuate slot radially opposed to said rotational axis; and a clamp disposed in said arcuate slot and cooperating with said arcuate slot for clamping said support plate to said alignment plate.

16. The system of claim 13, wherein said displacement of said indexing head support plate is parallel to said axis of rotation of said radial arm.

17. The system of claim 16, wherein said radial arm axis is substantially perpendicular to said plane of said planar cutting tool.

18. A method for making repeatable and progressively deeper arcuate cuts in a tile or ceramic material comprising the steps of,
mounting a radial arm on an axis of rotation;
mounting a rotating planar cutting tool on said radial arm mounted, with the plane of the planar cutting tool perpendicular to the direction of the radial arm and parallel to the axis of rotation of said radial arm;
indexing said planar cutting tool in the said plane of the cutting tool and in the direction of a work piece, to engage the work piece, and moving said radial arm about said radial arm axis of rotation to cause said cutting tool to arcuately engage a work piece to make an arcuate cut.

19. The method of claim 18, wherein said step of mounting said planar cutting tool comprises the step of mounting an alignment plate to said radial arm; mounting a support plate on for indexing movement on said alignment plate and mounting said cutting tool on said support plate.

20. The method of claim 19, wherein said step of indexing said cutting tool comprises the step of clamping said cutting tool in a preset position where it engages the work piece.
